(19) United States
(12) Patent Application Publication
(10) Pub. No.: US 2008/0131549 A1
(43) Pub. Date: Jun. 5, 2008

(54) MOLD FOR INJECTION MOLDING OF OPTICAL ELEMENTS

(75) Inventor: SHENG-JUNG YU, Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/940,855

(22) Filed: Nov. 15, 2007

(30) Foreign Application Priority Data
Dec. 1, 2006 (CN) 200610157311.4

(51) Int. Cl. B29C 45/64

(52) U.S. Cl. 425/186

(57) ABSTRACT

An exemplary optical mold includes a first plate and a second plate. The first plate includes a plurality of locating blocks. Each of the locating blocks includes a first inclined side surface. The second plate includes a frustum. The frustum includes at least one second inclined side surface (e.g., a plurality thereof for a pyramidal frustum; a single one for a conical frustum). The at least one second inclined side surface is configured for guiding the first plate to a predetermined position. The at least one second inclined side surface is in contact with the respective first inclined side surfaces when the first plate is assembled with the second plate to define at least one mold chamber between such plates.

### BACKGROUND

1. Technical Field

The present invention relates generally to molds and, particularly, to a mold for producing optical elements.

2. Description of Related Art

With the development of the optical imaging technology, camera devices, such as digital cameras and mobile phones, are widely used electronic devices. Optical elements (e.g., lenses) are one of the most critical components in any camera device. Optical elements are generally produced using injection molding.

A typical mold used in injection molding includes a stationary plate and a movable plate. When the movable plate is assembled with the stationary plate, leader pins and dowel pins guide the movable plate to a predetermined position relative to the stationary plate. In this position, a cavity is cooperatively formed between the stationary plate and the movable plate. Following the formation of the cavity, the molding material is fed into the cavity for molding.

However, the leader pin and the dowel pin may become abraded after the mold is used repeatedly. In cases of abrasion, the leader pin and the dowel pin are no longer able to precisely guide the movable plate to the predetermined position. Accordingly, each molding product made by the mold has a reduced precision (depending directly on the degree of abrasion), which can often be unacceptable for some optical elements, especially lenses.

It is, therefore, desirable to find a new mold that is capable of overcoming the above mentioned problems.

### SUMMARY

An exemplary optical mold includes a first plate and a second plate. The first plate includes a plurality of locating blocks. Each of the locating blocks includes a first inclined side surface. The second plate includes a frustum. The frustum includes at least one second inclined side surface (e.g., a plurality thereof for a pyramidal frustum; a single one for a conical frustum). The plurality of second inclined side surfaces are configured for guiding the first plate to a predetermined position. The plurality of second inclined side surfaces are in contact with the first inclined side surface, when the first plate is assembled with the second plate to define at least one mold chamber between such plates.

### BRIEF DESCRIPTION OF THE DRAWINGS

Many aspects of the present optical mold can be better understood with references to the following drawings. The components in the drawings are not necessarily drawn to scale, the emphasis instead being placed upon clearly illustrating the principles of the present optical mold. Moreover, in the drawings, like reference numerals designate corresponding parts throughout the several views.

FIG. 1 is a schematic, perspective view of an optical mold, according to a first embodiment;

FIG. 2 is a schematic, perspective inverted view of the optical mold of FIG. 1;

FIG. 3 is a schematic, perspective view of the optical mold of FIG. 1 in assembly;

FIG. 4 is a schematic, side cross-sectional view of the optical mold of FIG. 3, taken along the line IV-IV thereof;

FIG. 5 is a schematic, perspective view of a movable plate, according to a second embodiment;

FIG. 6 is a schematic, perspective view of a movable plate, according to a third embodiment; and

FIG. 7 is a schematic, perspective view of a stationary plate, according to a fourth embodiment.

### DETAILED DESCRIPTION OF THE EMBODIMENTS

Embodiments will now be described in detail below with reference to the drawings.

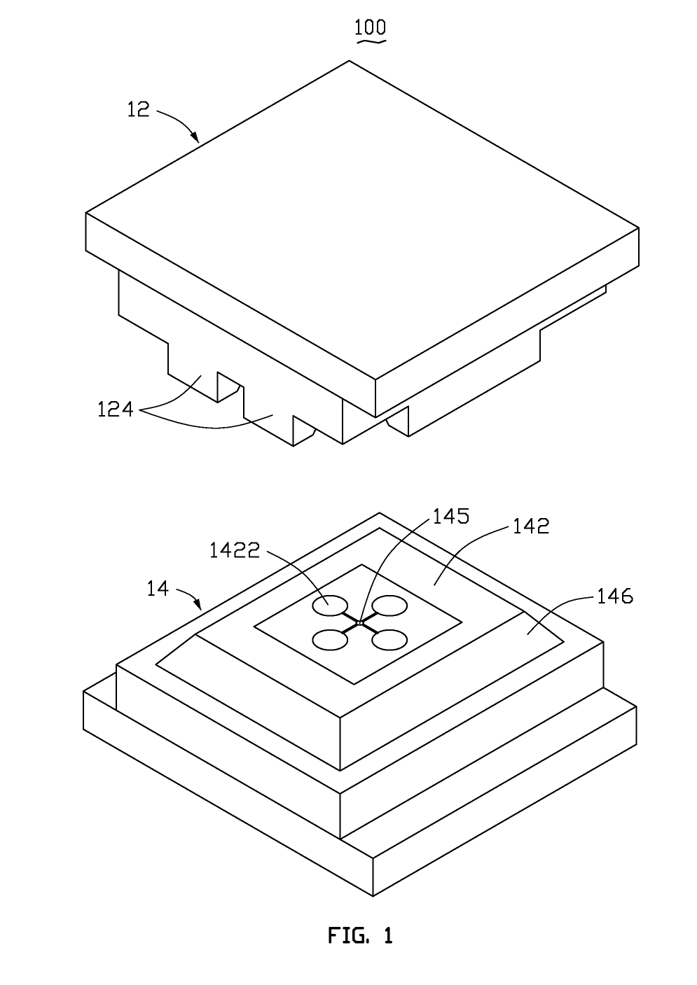

Referring to FIG. 1, an optical mold 100 of a first embodiment is shown. The optical mold 100 includes a stationary plate 14 and a movable plate 12 facing the stationary plate 14.

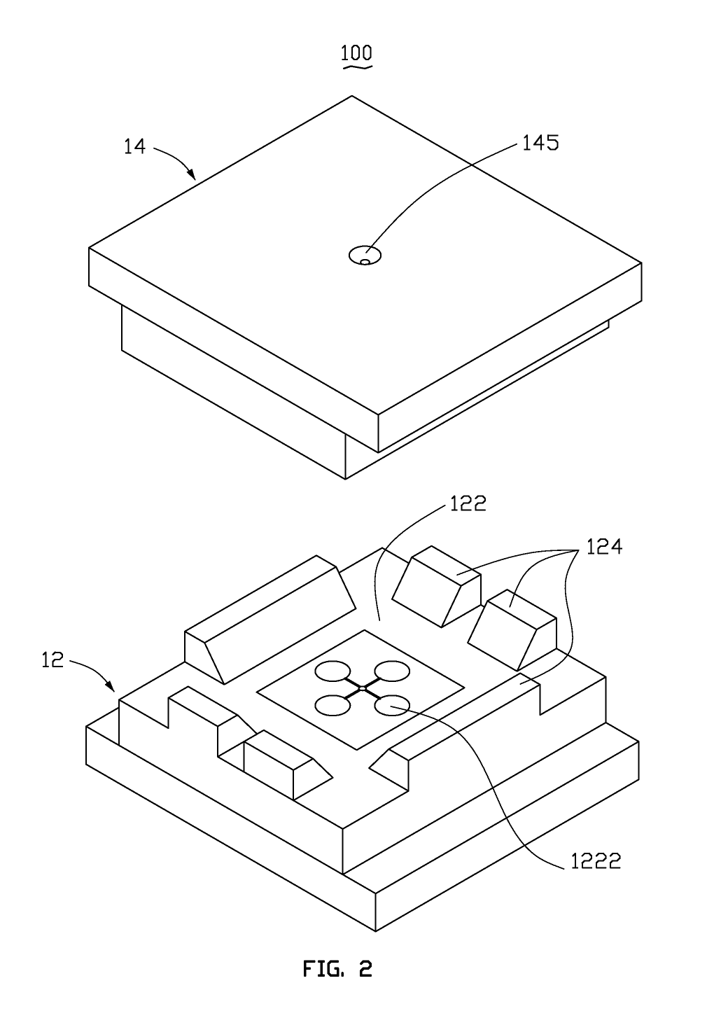

The stationary plate 14 includes a pyramid frustum 146, a plurality of cavities 1422 (i.e., each being one half of a mold form or chamber 1022) defined in the pyramid frustum 146, and a sprue 145. The pyramid frustum 146 includes a top surface 142 and four inclined side surfaces (not labeled). The pyramid frustum 146 is perfectly matched with the movable plate 12, and the four inclined side surfaces are configured for precisely guiding the movable plate 12 to a predetermined position. The sprue 145 is configured for feeding/channeling molding material therethrough (see FIG. 2).

Referring to FIG. 2, the movable plate 12 includes a bottom surface 122, a plurality of locating blocks 124, and a plurality of cavities 1222 (i.e., each being another half of a mold form or chamber 1022, for use with a respective cavity 1422) defined therein. The locating blocks 124 are formed on the bottom surface 122. The locating blocks 124 cooperatively form a frustum-shaped space. The frustum-shaped space is configured for receiving the pyramid frustum 146 of the first plate 14 (see FIG. 1). The plurality of cavities 1222 is surrounded by the locating blocks 124. In the present embodiment, the number of the locating blocks shown is six. Only one locating block 124 can be formed on each of the first side and the opposite second side, and two locating blocks 124 can be formed on each of the third side and the opposite fourth side. Each of the locating blocks 124 includes an inclined surface facing the cavities 1222. Each of the two locating blocks 124 on a same side has an inclined surface of an angle identical to the other. Further, the angle of the inclined surface of a given locating block 124 is the same as that of the mating portion of the corresponding inclined surface portion of the pyramid frustum 146. Because of such angular matching, the desired guided and precise fit between the locating blocks 124 and the pyramid frustum 146 is made possible.

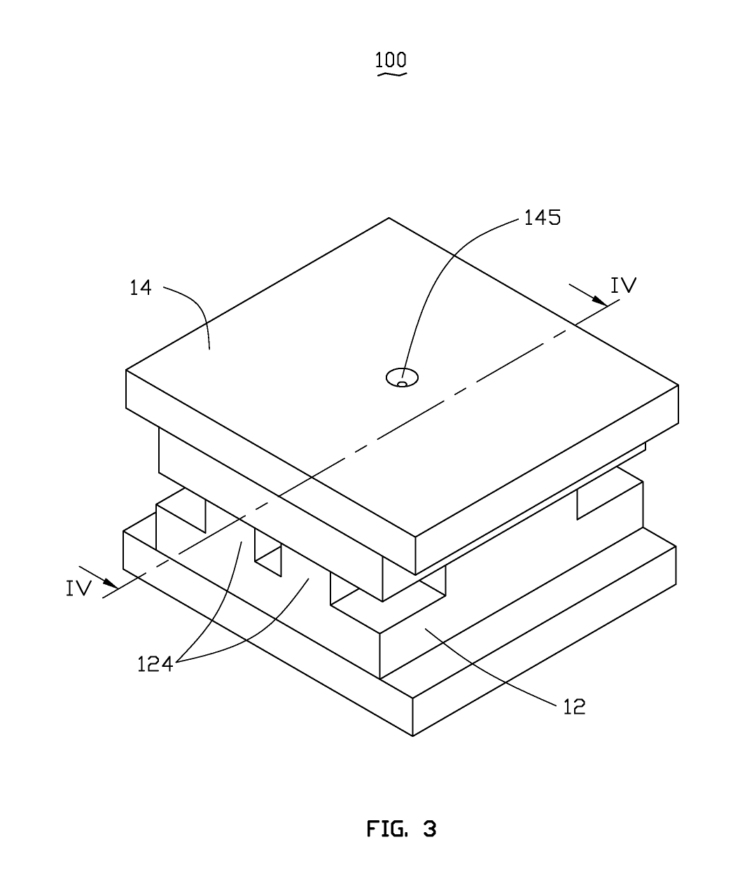

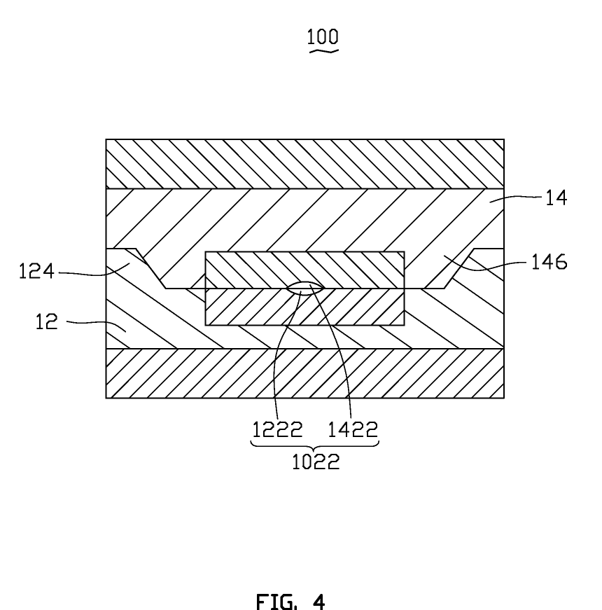

When the movable plate 12 is assembled with the stationary plate 14, the cavities 1222 and 1422 cooperatively form respective chambers 1022 (i.e., mold forms), referring to FIGS. 3 and 4. In this case, the bottom surface 122 of the movable plate 12 is in contact with the top surface 142 of the stationary plate 14. The inclined surfaces of the locating blocks 124 are in contact with the four side surfaces of the pyramid frustum 146 (see also FIGS. 1 and 2). In this way, the cavities 1222 are exactly aligned with the cavities 1422. Further, while the chamber 1022 shown in FIG. 4 is configured for molding a convex lens, it is to be understood that the shape/configuration of the individual cavities 1222 and 1422 can be chosen to yield any of various other shaped products (e.g., concave lens, concavo-convex lens, flat lens (e.g., as a filter or protective lens), grated lens, etc.).

In the molding process, a molding material is first fed into the chambers 1022 through the sprue 145, and then the molding material is cooled. Next, the movable plate 12 is raised, and a molded product (not shown) is taken out. After the molded product (e.g., a lens, a light filter, etc.) is taken out, the movable plate 12 is assembled with the stationary plate 14 again, and the next molding cycle is started.

The optical mold 100 can advantageously be used to manufacture optical elements (e.g., lenses) for camera module but could potentially be used to produce other sorts of elements, as well. In the above embodiment, the pyramid frustum 146 includes four inclined side surfaces, and each of the locating blocks 124 includes an inclined surface. When the movable plate 12 is assembled with the stationary plate 14, the four inclined side surfaces precisely guide the movable plate 12 to a predetermined position, using the inclined surfaces of the locating blocks 124 to promote the desired positioning. For example, if plates 12 and 14 are misaligned somewhat at start of molding process, the impingement of a respective pair of inclined side surfaces ultimately forces the desired alignment, due to interaction of such inclined surfaces. Thus, when the movable plate 12 is assembled with the stationary plate 14, the cavities 1222 are exactly aligned with the cavities 1422 by the time the movable plate 12 is immediately adjacent (i.e., in contact with) the stationary plate 14. The molded product made using the optical mold 100 has a high precision. Accordingly, centering error of the lenses produced by the optical mold 100 is decreased. Additionally, because of the inclined surfaces employed, even with some wear, the optical mold 100 will still promote centering/aligning of a given cavity 1222 with a corresponding cavity 1422.

It should be noted that the pyramid frustum 146 can also be formed on the movable plate 12 instead of the stationary plate 14. Correspondingly, the locating blocks 124 can be formed on the stationary plate 14 instead of the movable plate 12.

It should also be noted that the plurality of the locating blocks 124 can also be formed continuously and integrally.

In the present embodiment, the pyramid frustum 146 is a rectangular pyramid frustum. Alternatively, the frustum of rectangular pyramid 146 can be a conical frustum or other pyramid frustums, such as: a triangular pyramid frustum or a pentagonal pyramid frustum. Correspondingly, the inclined surfaces of the locating blocks 124 should be changed, to match/mate with the frustum shape chosen.

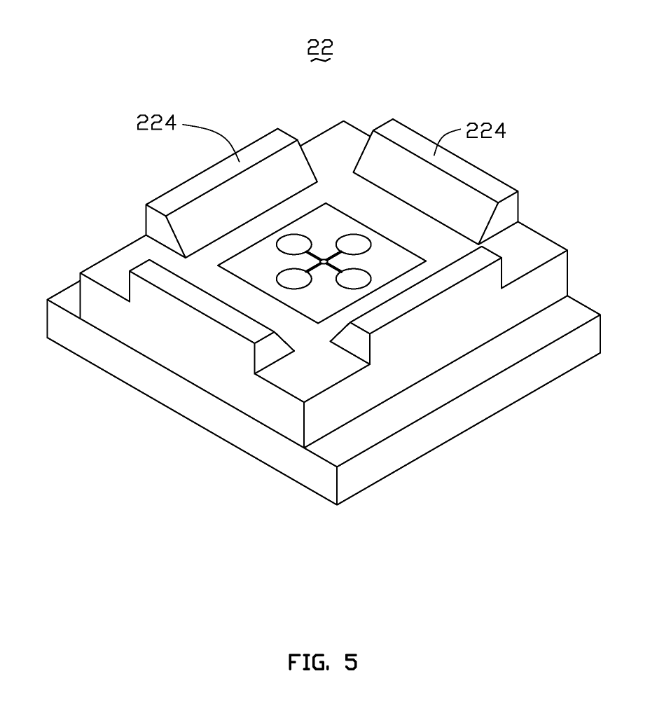

Referring to FIG. 5, a movable plate 22 of a second embodiment is shown. The movable plate 22 is similar to the movable plate 12, but only four locating blocks 224 are formed on the movable plate 22. One given locating block 224 is formed on each respective side of the movable plate 22.

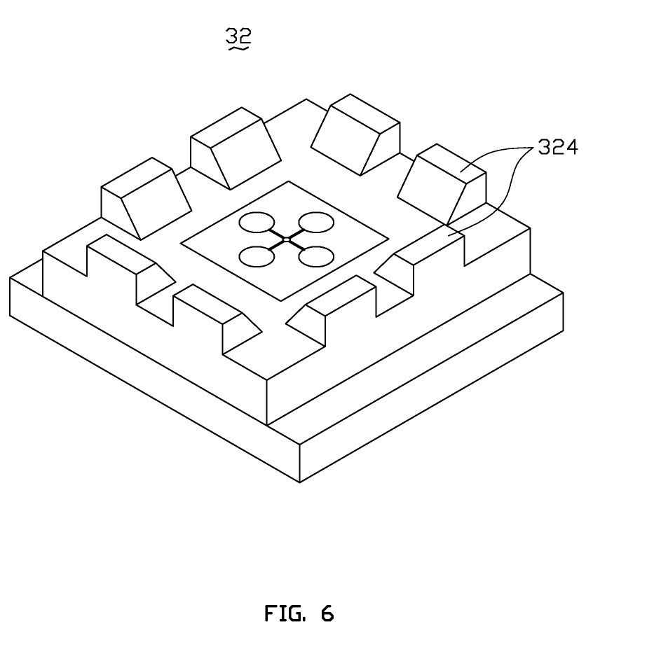

Referring to FIG. 6, a movable plate 32 of a third embodiment is shown. The movable plate 32 is similar to the movable plate 12, but eight locating blocks 324 are formed on the movable plate 32. As such, two locating blocks 324 are formed on each respective side of the movable plate 32.

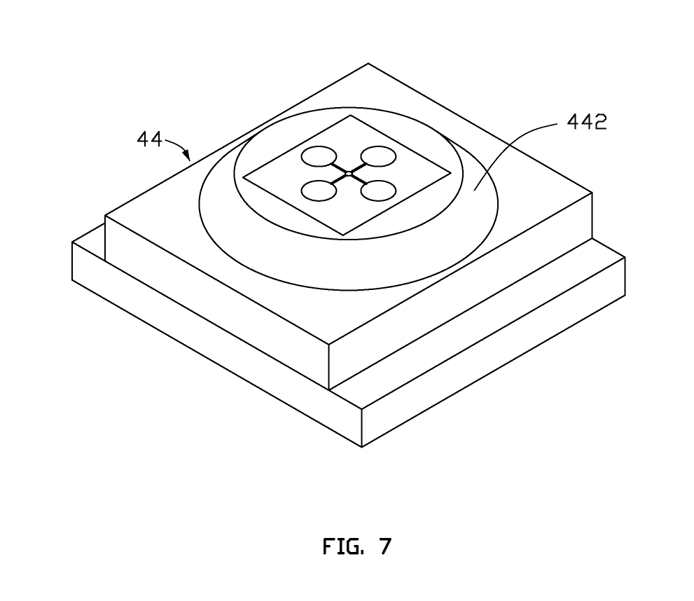

Referring to FIG. 7, a stationary plate 44 of a fourth embodiment is shown. The stationary plate 44 is similar to stationary plate 14, but the frustum 442 is a conical frustum, having thus just one inclined surface associated therewith, instead of a pyramid frustum.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An optical mold comprising:
a first plate comprising a plurality of locating blocks, each of the locating blocks comprising a first inclined side surface; and
a second plate including a frustum, the frustum comprising at least one second inclined side surface, the at least one second inclined side surface being configured for guiding the first plate to a predetermined position, the at least one second inclined side surface being in contact with the respective first inclined side surfaces when the first plate is assembled with the second plate.

2. The optical mold as claimed in claim 1, wherein the frustum is a pyramid frustum or a conical frustum.

3. The optical mold as claimed in claim 2, wherein the frustum is a pyramid frustum, the pyramid frustum being a rectangular pyramid frustum.

4. The optical mold as claimed in claim 1, wherein the first plate is fixed, and the second plate is movable.

5. The optical mold as claimed in claim 1, wherein the first plate is movable, and the second plate is fixed.

6. The optical mold as claimed in claim 1, wherein the first plate has at least one first cavity defined therein, and the second plate has at least one second cavity defined therein, a given first cavity and a corresponding second cavity cooperatively forming a respective chamber.

7. An optical mold comprising:
a first plate comprising a frustum, the frustum defining at least one first inclined side surface; and
a second plate comprising a plurality of locating blocks, the locating blocks cooperatively forming a frustum-shaped space, the frustum-shaped space being configured for receiving the frustum of the first plate, each of the locating blocks comprising a second inclined side surface, each respective second inclined side surface being in contact with a corresponding first inclined side surface when the first plate is assembled with the second plate.

8. The optical mold as claimed in claim 7, wherein the frustum is a pyramid frustum or a conical frustum.

9. The optical mold as claimed in claim 8, wherein the frustum is a pyramid frustum, the pyramid frustum being a rectangular pyramid frustum.

10. The optical mold as claimed in claim 7, wherein the first plate is fixed, and the second plate is movable.

11. The optical mold as claimed in claim 7, wherein the first plate is movable, and the second plate is fixed.

12. The optical mold as claimed in claim 7, wherein the first plate has at least one first cavity defined therein, and the second plate has at least one second cavity defined therein, a given first cavity and a corresponding second cavity cooperatively forming a respective chamber.
